(19) United States
(12) Patent Application Publication
(10) Pub. No.: US 2020/0094827 A1
(43) Pub. Date: Mar. 26, 2020

(54) APPARATUS FOR CONTROLLING AUTONOMOUS VEHICLE AND CONTROL METHOD THEREOF

(71) Applicant: LG Electronics Inc., Seoul (KR)

(72) Inventor: Suho PARK, Seoul (KR)

(21) Appl. No.: 16/588,342

(22) Filed: Sep. 30, 2019

(30) Foreign Application Priority Data
Aug. 15, 2019 (KR) 10-2019-0099962

(51) Int. Cl. B60W 30/16; H04W 4/40; H04W 24/08; H04W 72/12; G05D 1/00

(52) U.S. Cl. CPC B60W 30/16; H04W 4/40; H04W 24/08; H04W 72/1278; B60W 2550/22; G05D 2201/0213; B60W 2550/408; B60W 2550/302; B60W 2530/10; G05D 1/0088

(57) ABSTRACT

Provided is an autonomous-driving control method. The method includes setting a follow mode to follow a tracking vehicle, searching primary target vehicle candidates driving along the same driving path in a predetermined section, based on a V2X message received from surrounding vehicles, selecting a target vehicle to follow among the primary target vehicle candidates, approaching a rear end of the selected target vehicle, and following the target vehicle while approaching the target vehicle. One or more of an autonomous vehicle, a user terminal and a server of the present invention can be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATION

This application is based on and claims priority under 35 U.S.C. 119 to Korean Patent Application No. 10-2019-0099962, filed on Aug. 15, 2019, the contents of which are incorporated by reference.

### BACKGROUND OF THE INVENTION

### Field of the invention

The present invention relates to an autonomous-driving control apparatus and an autonomous-driving control method using the apparatus and, more particularly, to an autonomous-driving control apparatus and an autonomous-driving control method using the apparatus, which are capable of increasing fuel efficiency.

### Related Art

Vehicles can be classified into an internal combustion engine vehicle, an external combustion engine vehicle, a gas turbine vehicle, an electric vehicle or the like, according to the prime mover that is used. Recently, research on autonomous vehicles, which can perform self-driving with little or no driver's operation, is being actively conducted.

In an autonomous driving system, a platooning method has been proposed as a method for increasing the fuel efficiency of vehicles and reducing a road occupancy ratio.

However, the platooning aims at only the vehicles having the same destination. The platooning may be difficult depending on road conditions or traffic congestion degrees.

### SUMMARY OF THE INVENTION

The present invention is to solve the above-described problems.

Furthermore, the present invention provides an autonomous-driving control method and control apparatus, capable of increasing fuel efficiency.

Particularly, the present invention provides an autonomous-driving control method and control apparatus, capable of increasing fuel efficiency even in a situation where platooning is difficult.

In an aspect, an autonomous-driving control method may include setting a follow mode to follow a tracking vehicle; searching primary target vehicle candidates driving along the same driving path in a predetermined section, based on a V2X message received from surrounding vehicles; selecting a target vehicle to follow, among the primary target vehicle candidates; approaching a rear end of the selected target vehicle; and following the target vehicle while approaching the target vehicle.

The setting of the follow mode to follow the tracking vehicle may include determining a channel busy ratio; and setting a tracking mode, when the channel busy ratio is equal to or less than a preset threshold.

The searching of the primary target vehicle candidates may include searching a vehicle having the same running direction, which is predicted at the nearest intersection, based on driving history information and steering information of the V2X message.

The selecting of the target vehicle may include selecting, as the target vehicle, a vehicle having the largest vehicle body, among the primary target vehicle candidates.

The selecting of the target vehicle may include selecting, as the target vehicle, a vehicle whose driving speed is the highest, among the primary target vehicle candidates.

The selecting of the target vehicle may include selecting, as the target vehicle, a vehicle whose fuel efficiency is the highest, among the primary target vehicle candidates.

The selecting of the target vehicle may include calculating a first weight, based on a vehicle-body size of each of the primary target vehicle candidates; calculating a second weight, based on a driving speed of each of the primary target vehicle candidates; and selecting, as the target vehicle, a vehicle whose a sum of the first weight and the second weight is largest, among the primary target vehicle candidates.

At the approaching of the rear end of the target vehicle, a vehicle may approach an area where air resistance is reduced by the target vehicle.

The following of the target vehicle may further include determining whether the target vehicle deviates, based on the V2X message; and releasing the follow mode, when the target vehicle deviates from a host vehicle.

The determining whether the target vehicle deviates may include determining whether a situation in which a distance between the target vehicle and the host vehicle is increased by a traffic facility occurs.

The determining whether the target vehicle deviates may include determining whether a situation in which an expected driving path of the target vehicle is different from a driving path of the host vehicle occurs.

In another aspect, an autonomous-driving control apparatus may include an on board unit configured to receive a V2X message from surrounding vehicles; a follow-mode control unit configured to search primary target vehicle candidates driving along the same driving path in a predetermined section based on the V2X message, and to select a target vehicle to follow among the primary target vehicle candidates, in the case of setting a tracking mode; and an autonomous-driving control unit configured to control an actuating device to approach a rear end of the target vehicle and then follow the target vehicle, based on a determined result of the follow-mode control unit.

The follow-mode control unit may set the tracking mode, when a channel busy ratio is equal to or less than a preset threshold.

The follow-mode control unit may select, as the primary target vehicle candidates, a vehicle having the same running direction, which is predicted at the nearest intersection, based on driving history information and steering information of the V2X message.

The follow-mode control unit may select, as the target vehicle, a vehicle having the largest vehicle body, among the primary target vehicle candidates.

The follow-mode control unit may select, as the target vehicle, a vehicle whose driving speed is the highest, among the primary target vehicle candidates.

The follow-mode control unit may select, as the target vehicle, a vehicle whose fuel efficiency is the highest, among the primary target vehicle candidates.

The follow-mode control unit may calculate a first weight based on a vehicle-body size of each of the primary target vehicle candidates, may calculate a second weight based on a driving speed of each of the primary target vehicle candidates, and may select, as the target vehicle, a vehicle whose a sum of the first weight and the second weight is largest among the primary target vehicle candidates.

The autonomous-driving control unit may control the actuating device to approach an area where air resistance is reduced by the target vehicle.

The follow-mode control unit may determine whether the target vehicle deviates, based on the V2X message, and may release the follow mode, when it is determined that the target vehicle deviates from a host vehicle.

The present invention has an advantage in that it can increase fuel efficiency, by following a target vehicle even if platooning is not performed.

Particularly, the present invention has an advantage in that a follow mode is set based on a V2X message received in real time, so that it is possible to drive while increasing fuel efficiency even in a situation where platooning is difficult depending on road conditions and traffic volumes.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram referred to in description of a usage scenario of a user according to an embodiment of the present invention.

FIG. 10 shows an example of a type of V2X application.

FIG. 11 is a diagram showing a follow-mode control system according to an embodiment of the present invention.

FIG. 12 is a flowchart showing a follow-mode based autonomous-driving control method according to an embodiment of the present invention.

FIG. 13 is a flowchart showing an embodiment of setting a follow mode.

FIG. 14 is a flowchart showing an embodiment of selecting a target vehicle to follow.

FIG. 15 is a diagram illustrating the embodiment of selecting the target vehicle.

FIG. 16 is a flowchart showing a method of selecting a target vehicle according to another embodiment.

FIG. 17 is a flowchart showing an embodiment of releasing the target vehicle.

FIG. 18 is a flowchart showing another embodiment of releasing the target vehicle.

FIG. 19 is a diagram illustrating a situation in which the target vehicle deviates due to a traffic light at an intersection.

FIG. 20 is a diagram illustrating a situation in which the target vehicle deviates due to a change in driving path.

FIG. 21 is a diagram illustrating a situation in which the target vehicle deviates due to the parking and stopping of the target vehicle.

FIG. 22 is a diagram illustrating a signal processing and procedure of a follow-mode based autonomous-driving control method according to an embodiment of the present invention.

FIG. 23 illustrates an example of a basic vehicle-to-vehicle operation using 5G communication.

FIG. 24 illustrates an embodiment wherein the 5G network is directly involved in the resource allocation of the signal transmission/reception.

FIG. 25 illustrates an embodiment wherein the 5G network is indirectly involved in the resource allocation of the signal transmission/reception.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

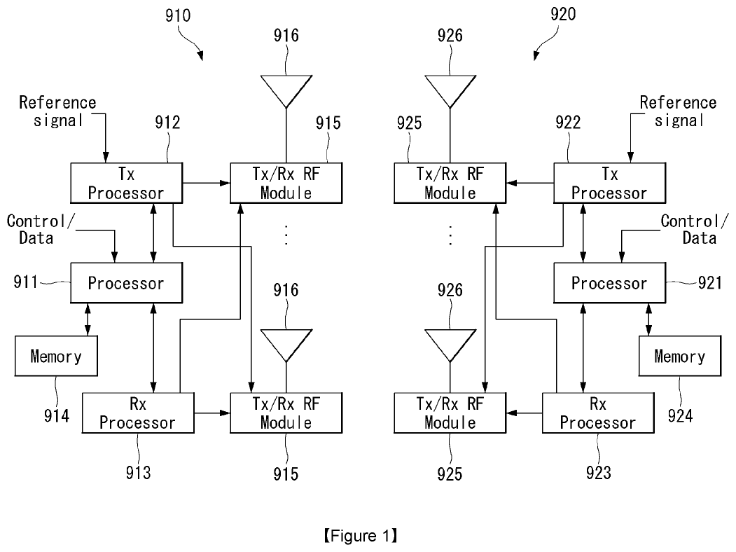

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

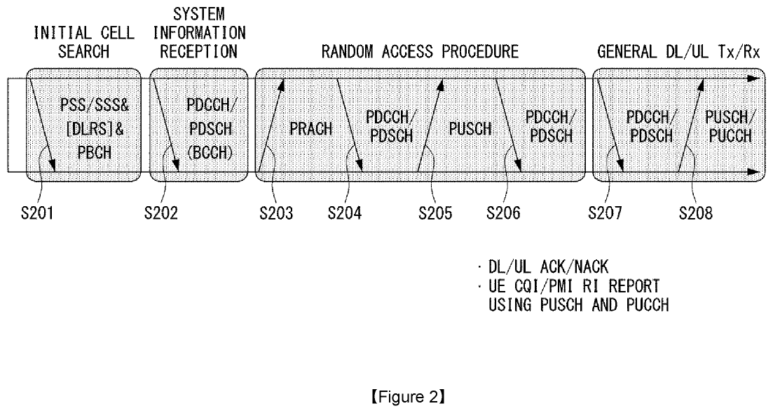

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SIBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-striggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCl by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles using 5G Communication

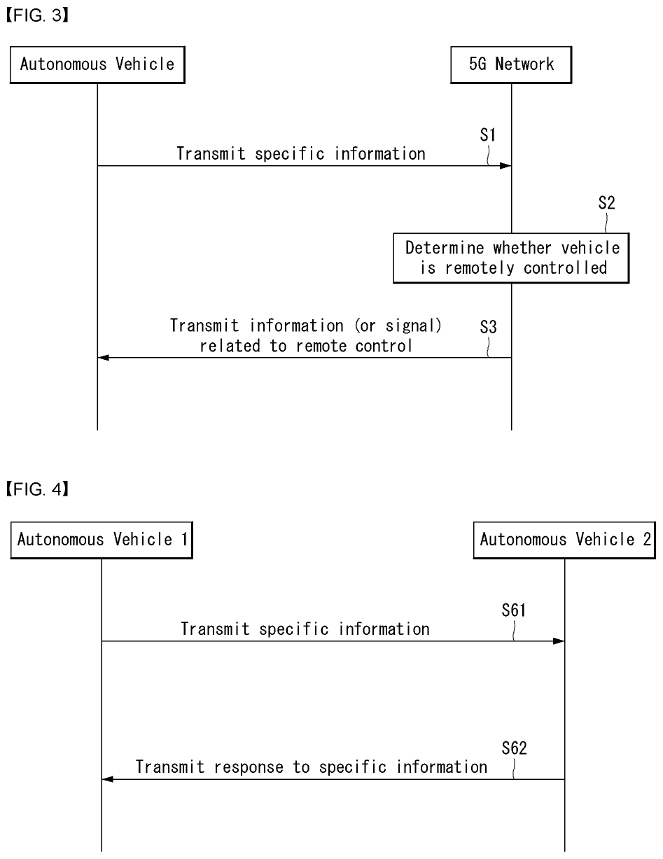

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation between Vehicles using 5G Communication

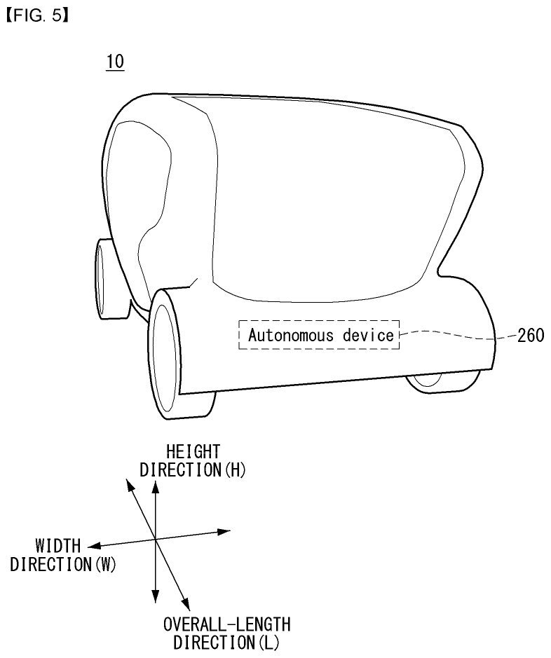

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

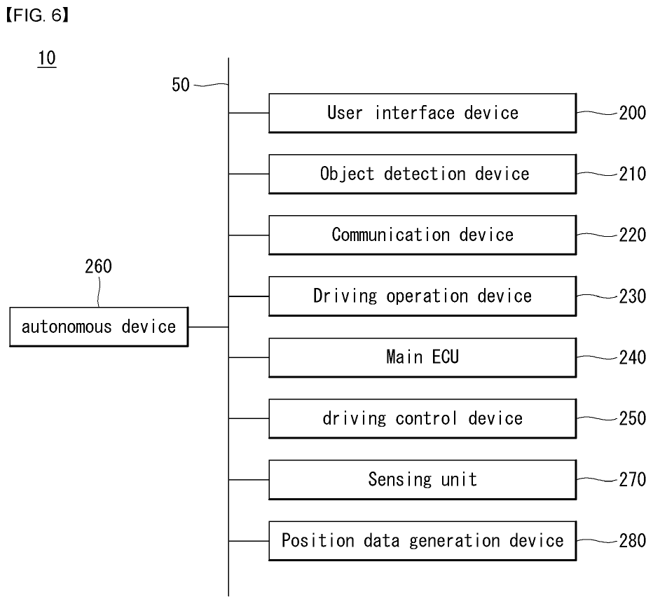

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

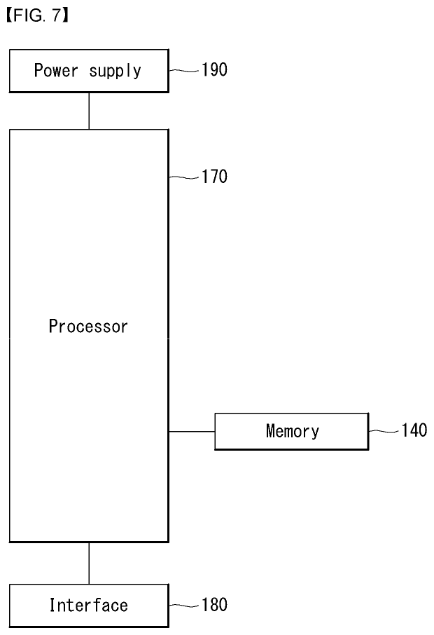

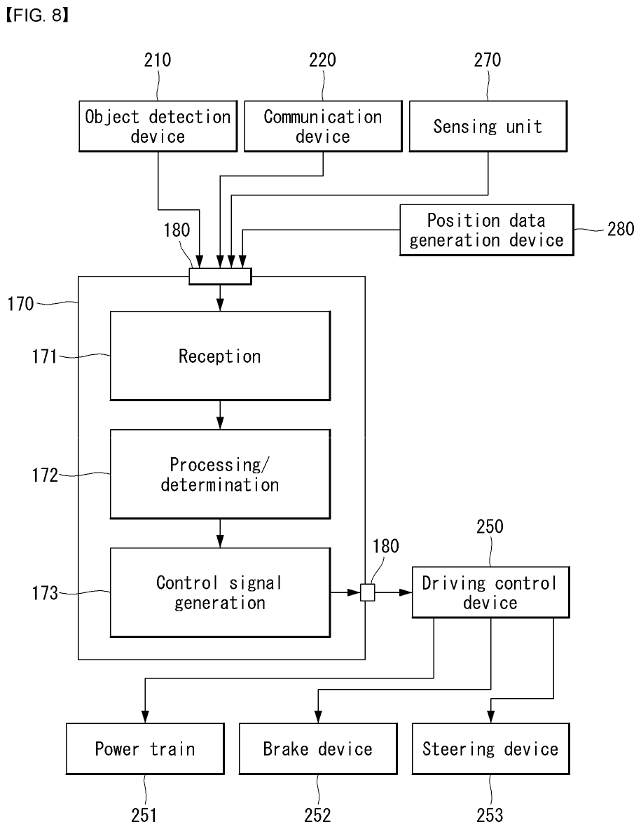

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

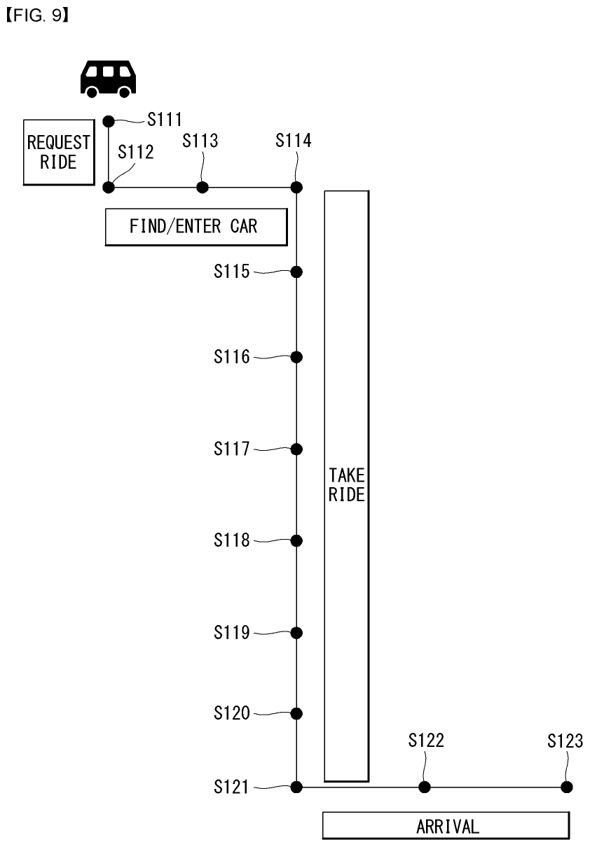

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

(2) Autonomous Vehicle Usage Scenarios

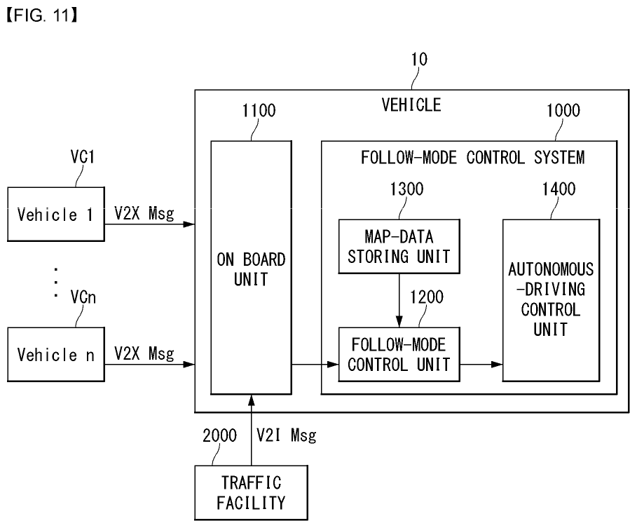

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present invention which will be described later and applied or can complement the methods proposed in the present invention to make technical features of the present invention concrete and clear.

Hereinafter, various embodiments of the present invention will be described in detail with reference to the attached drawings.

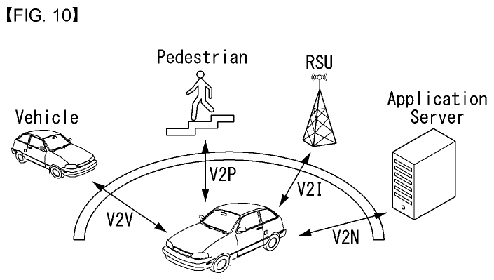

FIG. 10 illustrates V2X communication to which the present invention is applicable.

V2X (vehicle-to-everything) refers to communication technology that exchanges information with other vehicles, pedestrians, and objects with infrastructures through wired/wireless communication. V2X may be classified into four types, namely, a vehicle-to-vehicle (V2V) designating communication between vehicles, a vehicle-to-infrastructure (V2I) designating communication between a vehicle and an eNB or an RSU (road side unit), vehicle-to-pedestrian (V2P) designating communication between UEs of a vehicle and an individual (pedestrians, bicycle drivers, vehicle drivers, or passengers), and a vehicle-to-network (V2N)..

A V2X communication may have the same meaning as a V2X sidelink or NR V2X or a wider meaning including a V2X sidelink or NR V2X.

V2X communication may be provided through a PC5 interface and/or the Uu interface. In this case, in a wireless communication system supporting V2X communication, there may exist specific network entities for supporting communication between the vehicle and all the entities. For example, the network entity may be a BS (eNB), a roadside unit (RSU), a UE, or an application server (e.g., a traffic safety server), etc.

In addition, the UE performing V2X communication may refer to vehicle UE (V-UE), pedestrian UE, BS type (eNB type) RSU, UE type RSU, a robot having a communication module, and the like, as well as general handheld UE.

V2X communication may be performed directly between UEs or through the network entity(s). The V2X operation mode may be classified according to a method of performing V2X communication.

Meanwhile, as more communication devices require larger communication capacities, there is a need for improved mobile broadband communication compared to the existing Radio Access Technology (RAT). Accordingly, a communication system considering a service or a terminal sensitive to reliability and latency is being discussed. Next-generation radio access technology considering improved mobile broadband communication, massive MTC, Ultra-Reliable and Low Latency Communication (URLLC), etc. may be referred to as new radio access technology (RAT) or new radio (NR). The V2X (vehicle-to-everything) communication may be supported in the NR.

The following technology can be used for various wireless communication systems, such as CDMA (code division multiple access), FDMA (frequency division multiple access), TDMA (time division multiple access), OFDMA (orthogonal frequency division multiple access) or SC-FDMA (single carrier frequency division multiple access). The CDMA may be implemented with wireless technology such as UTRA (universal terrestrial radio access) or CDMA2000. The TDMA may be implemented with wireless technology such as GSM (global system for mobile communications)/GPRS (general packet radio service)/EDGE (enhanced data rates for GSM evolution). The OFDMA may be implemented with wireless technology such as IEEE (institute of electrical and electronics engineers) 802.11 (Wi-Fi), IEEE 802.16 (WiMAX), IEEE 802-20 or E-UTRA (evolved UTRA). The IEEE 802.16m is an evolution of IEEE 802.16e, and provides backward compatibility with a system based on the IEEE 802.16e. The UTRA is a part of UMTS (universal mobile telecommunications system). 3GPP (3rd generation partnership project) LTE (long term evolution) is a part of E-UMTS (evolved UMTS) using E-UTRA (evolved-UMTS terrestrial radio access), adopts the OFDMA at the downlink and adopts the SC-FDMA in the uplink. LTE-A (advanced) is an evolution of 3GPP LTE.

5G NR is succeeding technology of the LTE-A and is a new clean-slate type of mobile communication system having characteristics such as high performance, low latency, and high availability. 5G NR can utilize all available spectral resources which are in the range of a low frequency band below 1 GHz, a medium frequency band of 1 GHz to 10 GHz, and a high frequency (millimeter wave) band above 24 GHz.

For the clarity of description, the LTE-A or the 5G NR is mainly described, but the technical spirit of the invention is not limited thereto.

The above-describe 5G communication technology can be combined with methods proposed in the present invention which will be described later and applied or can complement the methods proposed in the present invention to make technical features of the present invention concrete and clear.

Hereinafter, various embodiments of the present invention will be described in detail with reference to the attached drawings.

Follow-Mode Control System

FIG. 11 is a diagram showing a follow-mode control system according to an embodiment of the present invention.

Referring to FIG. 11, a follow-mode control system 1000 mounted on a vehicle 10 includes an on board unit 1100, a follow-mode control unit 1200, a map-data storing unit 1300, and an autonomous-driving control unit 1400. The follow-mode control system 1000 may use or include components shown in FIGS. 6 and 8. For example, the on board unit 1100 may correspond to at least some components of the communication device 220. Furthermore, the autonomous-driving control unit 1400 may correspond to the vehicle actuating device 250.

As described with reference to vehicles and FIG. 9, the on board unit (OBU) 1100 receives information from another vehicle, a pedestrian, a thing in which an infrastructure is built or the like through V2X communication. The on board unit 1100 is provided with a V2X message from adjacent vehicles. The V2X message includes “driving history information” and “steering information” of the vehicles. Furthermore, the on board unit 1100 receives a V2I message from traffic facilities 2000.

The follow-mode control unit 1200 sets a driving path based on map data information stored in the map-data storing unit 1300. The follow-mode control unit 1200 sets a tracking mode on the basis of a channel busy ratio. In the case of setting the tracking mode, primary target vehicle candidates, which are driven along the same driving path in a predetermined section based on the V2X message received from the on board unit 1100, are searched. Furthermore, the follow-mode control unit 1200 selects a target vehicle to follow among the primary target vehicle candidates.

The autonomous-driving control unit 1400 controls the actuating device based on the determined result of the follow-mode control unit 1200. For example, according to the determined result of the follow-mode control unit 1200, the autonomous-driving control unit 1400 may control the actuating device to approach a rear end of the target vehicle and then follow the target vehicle.

Follow-Mode Based Autonomous-Driving Control Method

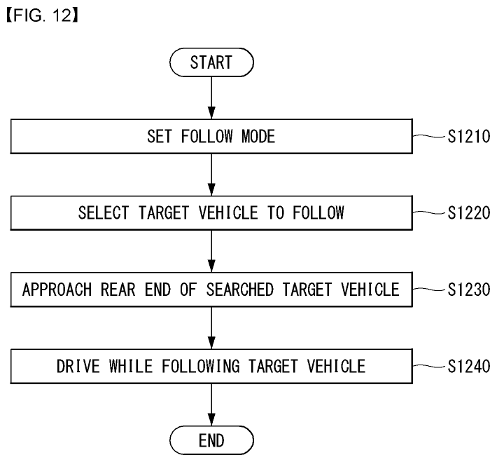

FIG. 12 is a flowchart showing a follow-mode based autonomous-driving control method according to an embodiment of the present invention.

Referring to FIG. 12, at a first step S1210 of the follow-mode based autonomous-driving control method, the follow-mode control unit 1200 of the vehicle 10 sets a follow mode.

At a second step S1220, the follow-mode control unit 1200 selects a target vehicle to follow. The follow-mode control unit 120 may determine the driving paths of surrounding vehicles, based on the V2X message received from the surrounding vehicles and the V2I message received from the traffic facility 2000. The follow-mode control unit 1200 may select the target vehicle based on the size of a vehicle body and the speed among vehicles having the same driving path.

At a third step S1230, the autonomous-driving control unit 1400 controls the actuating device so that the vehicle 10 approaches the rear end of the target vehicle. To be more specific, the vehicle 10 approaches an area where air resistance is reduced by the target vehicle.

At a fourth step S1240, the vehicle 10 is driven while following the target vehicle. That is, since the vehicle 10 can be driven with less air resistance, fuel efficiency can be enhanced.

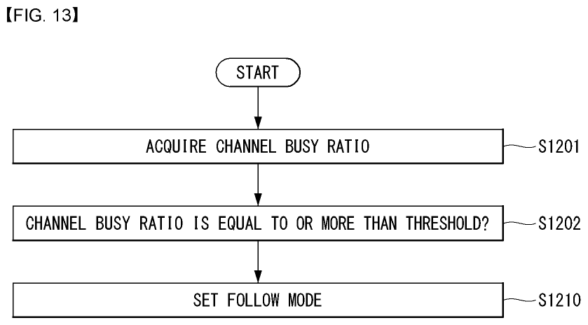

FIG. 13 is a flowchart showing an embodiment of setting the follow mode.

Referring to FIG. 13, in order to set the follow mode, the follow-mode control unit 1200 acquires a channel busy ratio, at a first step S1201. The channel busy ratio (CBR) refers to a ratio at which the channel is utilized within a data transmission period of a predetermined time period. Therefore, the channel busy ratio in the autonomous driving system is proportional to the number of vehicles and communication traffic between the vehicles.

At a second step S1202 and a third step S1210, the follow-mode control unit 1200 compares the channel busy ratio with a preset threshold, and sets the follow mode when the channel busy ratio is equal to or more than the preset threshold. The threshold may be set to such an extent that a traffic volume estimated on the basis of the channel busy ratio cannot facilitate platooning. That is, the follow-mode control unit 1200 may determine to drive in the follow mode, when the platooning is not easy.

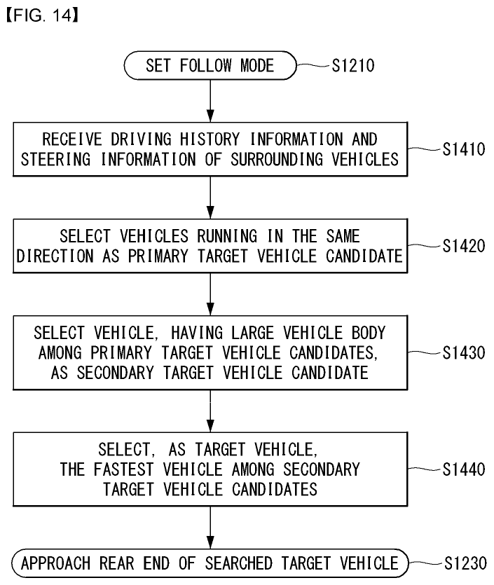

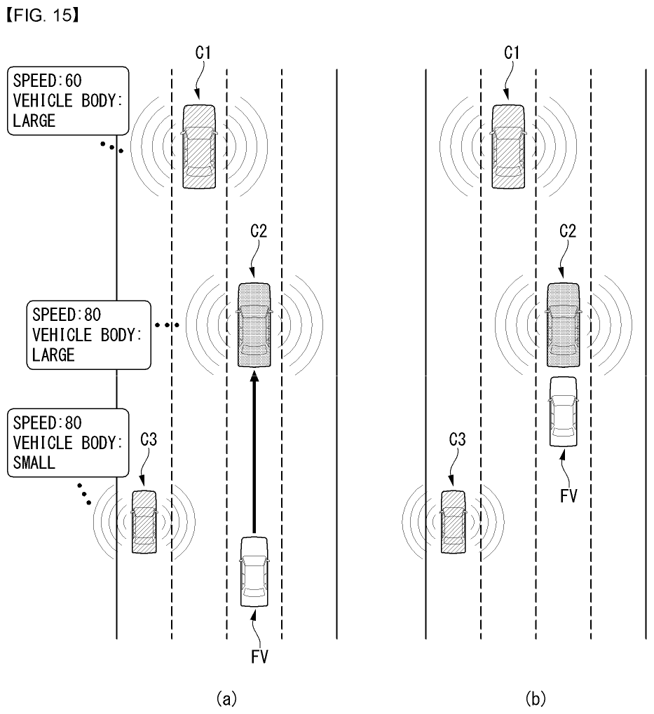

FIG. 14 is a flowchart showing an embodiment of selecting the target vehicle to follow. FIG. 15 is a diagram illustrating an embodiment of selecting the target vehicle.

Referring to FIGS. 14 and 15, when the follow mode is determined at step S1210, the target vehicle may be selected in consideration of the predicted driving path, the vehicle speed, and the vehicle-body size of surrounding vehicles. A situation where a following vehicle FV is running on a road whose regulated speed is 80 km/hr and goes straight at the next intersection is illustrated. In the following embodiments, the following vehicle FV refers to a vehicle that attempts autonomous driving using the follow mode according to the present invention.

At a first step S1410, the follow-mode control unit 1200 of the following vehicle FV acquires “driving history information” and “steering information” from the V2X message received from surrounding vehicles C1 to C3, and checks the driving information of the surrounding vehicles C1 to C3 based on the acquired information.

At a second step S1420, the follow-mode control unit 1200 selects a vehicle running in the same direction, as a primary target vehicle candidate. The follow-mode control unit 1200 may predict a driving path based on the driving lane, current running direction and steering information of the surrounding vehicles C1 to C3. As illustrated in FIG. 15, if the first to third vehicles C1 to C3 are driven in the same running direction as the following vehicle FV, the follow-mode control unit 1200 may select the first to third vehicles C1 to C3 as the primary target vehicle candidate.

At a third step S1430, the follow-mode control unit 1200 selects, as a secondary target vehicle candidate, a vehicle having a vehicle body exceeding a predetermined size among the primary target vehicle candidates. The follow-mode control unit 1200 may determine the vehicle-body size of the primary target vehicle candidates based on the information about the surrounding vehicles received through the V2X communication or the image information acquired by the following vehicle FV. The follow-mode control unit 1200 may determine that the vehicle-body size is large or small based on a preset reference value. For example, the reference value may correspond to the vehicle-body size of the following vehicle FV. Consequently, as illustrated in FIG. 15, the follow-mode control unit 1200 may select, as the secondary target vehicle candidate, the first and second vehicles C1 and C2 that are larger in size than the following vehicle FV.

At a fourth step S1440, the follow-mode control unit 1200 selects, as the target vehicle, the fastest vehicle among the secondary target vehicle candidates. For example, as illustrated in FIG. 15, when the first vehicle C1 is running at 60km and the second vehicle C2 is running at 80km, the follow-mode control unit 1200 may select the first vehicle C1 as the target vehicle.

Subsequently, the vehicle proceeds to the third step S1230 of FIG. 12 to approach the rear end of the target vehicle.

In the embodiment shown in FIG. 14, the third step S1430 and the fourth step S1440 may be changed in order of priority. That is, the secondary target vehicle candidate may be first selected on the basis of the speed, and the vehicle having the largest vehicle body among the secondary target vehicle candidates may be selected as the target vehicle. Furthermore, the follow-mode control unit 1200 may select the target vehicle using only one of the third step S1430 or the fourth step S1440. For example, the follow-mode control unit 1200 may select, as the target vehicle, the fastest vehicle among the primary target vehicle candidates. Alternatively, the follow-mode control unit 1200 may select, as the target vehicle, the vehicle having the highest fuel efficiency among the primary target vehicle candidates.

Furthermore, the follow-mode control unit 1200 may select the target vehicle in view of the fuel efficiency. The follow-mode control unit 1200 may calculate the fuel efficiency of each of the surrounding vehicles, based on the driving information of the surrounding vehicles. Based on the calculated result, the follow-mode control unit 1200 may select the surrounding vehicle having the highest fuel efficiency as the target vehicle.

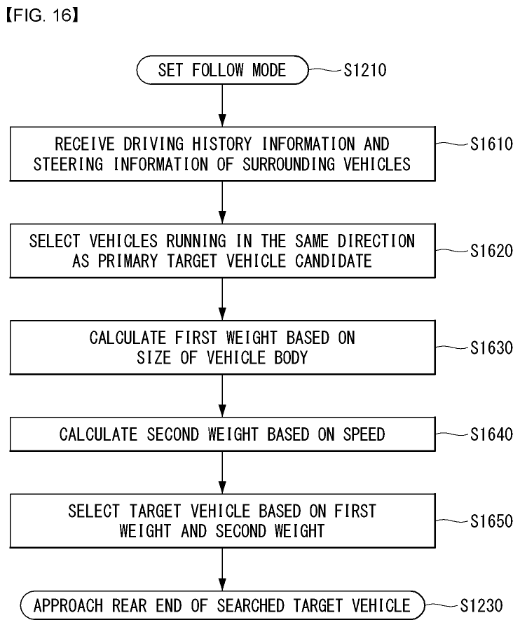

FIG. 16 is a flowchart showing a method of selecting a target vehicle according to another embodiment.

When the follow mode is determined at step S1210, the follow-mode control unit 1200 receives the driving history information and steering information of the surrounding vehicles at a first step S1610.

At a second step S1620, the follow-mode control unit 1200 selects vehicles running in the same direction as the primary target vehicle candidate, based on the driving history information and the steering information. The first step S1610 and the second step S1620 may use the same method as the embodiment shown in FIG. 14.

At a third step S1630, the follow-mode control unit 1200 calculates a first weight, based on the vehicle-body size. For example, the follow-mode control unit 1200 may assign the first weight to be proportional to the vehicle-body size, and consequently the primary target vehicle candidates may have a higher first weight, as the vehicle-body size increases.

At a fourth step S1640, the follow-mode control unit 1200 calculates a second weight, based on the speed. For example, the follow-mode control unit 1200 may assign the second weight to be proportional to the driving speed of the primary target vehicle candidates within the regulated speed, and consequently the primary target vehicle candidates may have a higher second weight, as the driving speed increases.

The third step S1630 and the fourth step S1640 may be procedures that are performed in parallel.

At a fifth step S1650, the follow-mode control unit 1200 selects the target vehicle based on the first weight and the second weight. For example, the follow-mode control unit 1200 may add the first weight and the second weight for each of the primary target vehicle candidates, and may select the vehicle whose the sum of the first and second weights is the highest as the target vehicle.

Subsequently, the vehicle approaches the rear end of the target vehicle, as in the procedure of the third step S1230 of FIG. 12.

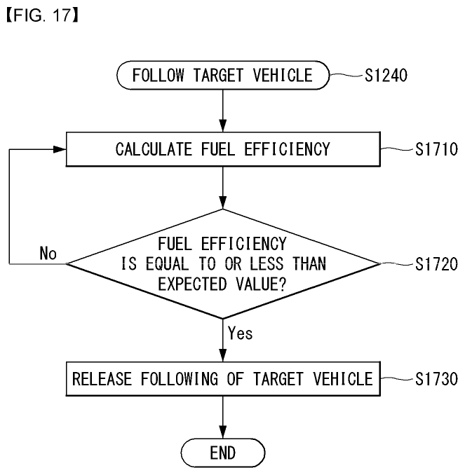

FIG. 17 is a flowchart showing an embodiment of releasing the target vehicle.

Referring to FIG. 17, the procedure for releasing the target vehicle presupposes that it proceeds with the step of following the target vehicle at the fourth step S1240 shown in FIG. 12.

At the first step S1710, the follow-mode control unit 1200 calculates fuel efficiency while a vehicle is driving. The follow-mode control unit 1200 may calculate the fuel efficiency while the vehicle is driving, in consideration of a driving speed and a reduction in air resistance by the target vehicle.

At a second step S1720, the follow-mode control unit 1200 compares the calculated fuel efficiency with a preset expected value.

At a third step S1730, when the fuel efficiency is equal to or less than the expected value while the vehicle is driving, the follow-mode control unit 1200 releases the follow mode. After releasing the follow mode, another target vehicle may be selected.

That is, when the vehicle is driving in the follow mode but the fuel efficiency is not improved as much as expected, the follow-mode control unit 1200 may release the follow mode for a current target vehicle.

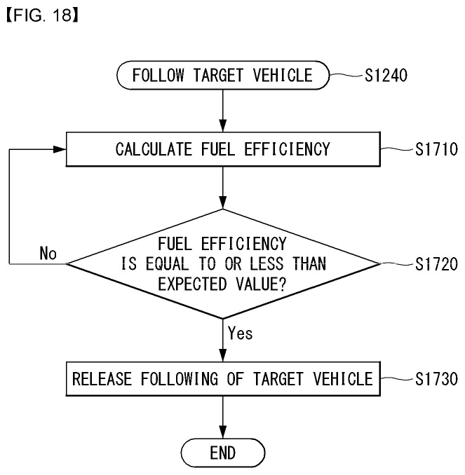

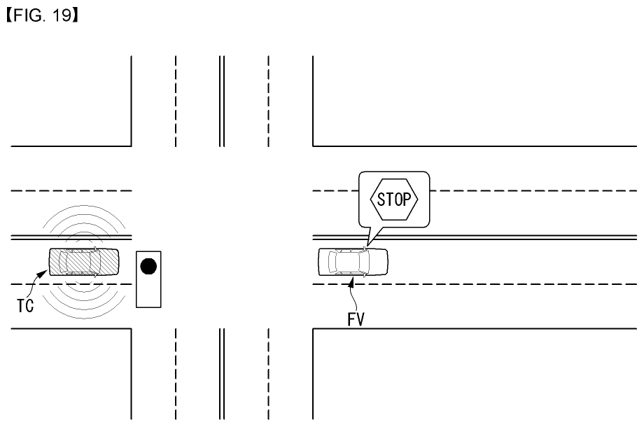

FIG. 18 is a flowchart showing another embodiment of releasing the target vehicle.

Referring to FIG. 18, the procedure for releasing the target vehicle presupposes that it proceeds with the step of following the target vehicle at the fourth step S1240 shown in FIG. 12.

At a first step S1810, the follow-mode control unit 1200 monitors the driving path of the target vehicle. The follow-mode control unit 1200 monitors the path along which the target vehicle drives, based on the steering information of the target vehicle and the V2I message from the traffic facility 2000.

At a second step S1820, the follow-mode control unit 1200 determines whether the target vehicle deviates from the driving path.

At a third step S1830, when the target vehicle deviates, the follow-mode control unit 1200 releases the follow mode for the target vehicle.

At the second step of FIG. 18, an embodiment for determining that the target vehicle deviates is as follows.

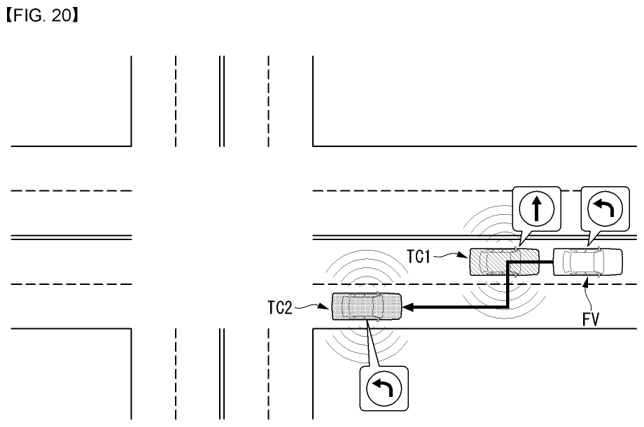

FIG. 19 is a diagram illustrating a situation in which the target vehicle deviates due to a traffic light at an intersection.

Referring to FIG. 19, in the state where the target vehicle TC passes through the intersection, the following vehicle FV may stop at the intersection by a stop sign of a traffic light. As such, when a distance between the target vehicle TC and the following vehicle FV is increased by the traffic facility 2000 such as the traffic light, the following vehicle FV releases the procedure for following the corresponding target vehicle TC.

FIG. 20 is a diagram illustrating a situation in which the target vehicle deviates due to a change in driving path.

Referring to FIG. 20, the following vehicle FV approaching the intersection will turn to the left, and the target vehicle TC1 will go straight. The following vehicle FV may predict the driving path of the target vehicle TC1 based on the V2X message from the target vehicle TC1, prior to approaching the intersection. When it is determined that the following vehicle will select a driving path different from that of the target vehicle TC1 at the intersection, the following vehicle FV releases the follow mode for the target vehicle TC1.

Furthermore, the following vehicle FV may search a new target vehicle TC2. For example, the following vehicle FV may search a new target vehicle TC2 according to the procedure shown in FIG. 14 or 16. When the new target vehicle TC2 is searched, the following vehicle FV may approach the rear end of the new target vehicle TC2 to drive in the follow mode.

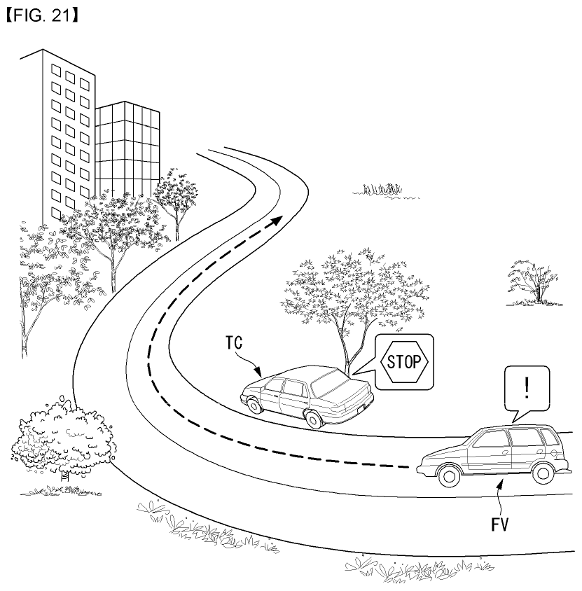

FIG. 21 is a diagram illustrating a situation in which the target vehicle deviates due to the parking and stopping of the target vehicle.

Referring to FIG. 21, the following vehicle FV can determine a situation where the target vehicle TC gets out of a road to be parked and stopped, based on road map information, the position information of the target vehicle TC, and the V2X message. When the target vehicle TC tries to be parked and stopped, the following vehicle FV may release the follow mode of the target vehicle TC.

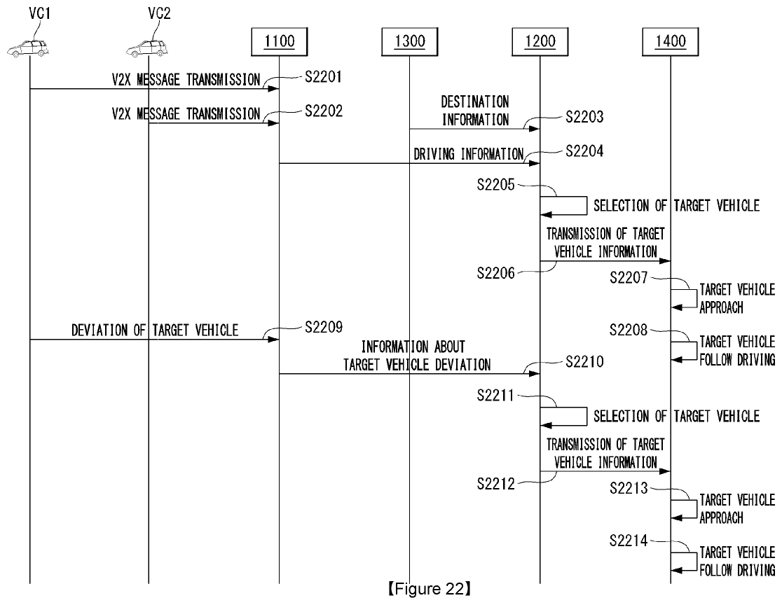

FIG. 22 is a diagram illustrating the signal processing and procedure of the follow-mode based autonomous-driving control method according to an embodiment of the present invention.

Referring to FIG. 22, at the first step S2201 and the second step S2202, the on board unit 1100 of the following vehicle determining the follow mode receives the V2X message from the surrounding vehicles VC1 and VC2.

At the third step S2203, prior to selecting the target vehicle, the follow-mode control unit 1200 sets a destination based on the road map information.

At fourth to sixth steps S2204, S2205 and S2206, the follow-mode control unit 1200 selects the target vehicle, based on the V2X message received from the surrounding vehicles VC1 and VC2 at a first step S2201 and a second step S2202. A method of selecting the target vehicle may use the procedure shown in FIG. 13 or 15.

At a seventh step S2207 and an eighth step S2208, when a first vehicle VC1 is selected as the target vehicle, the autonomous-driving control unit 1400 controls actuating devices to perform autonomous driving while following the first vehicle Cl.

At a ninth step S2209 and a tenth step S2210, the follow-mode control unit 1200 may determine that the target vehicle VC1 deviates, based on a V2X message from the first vehicle VC1 corresponding to the target vehicle.

At an eleventh step S2211 and a twelfth step S2212, the follow-mode control unit 1200 may select a new target vehicle based on the V2X message received from surrounding vehicles.

At a thirteenth step S2213 and a fourteenth step S2214, the autonomous-driving control unit 1400 controls the actuating devices to perform autonomous driving while following a newly selected target vehicle.

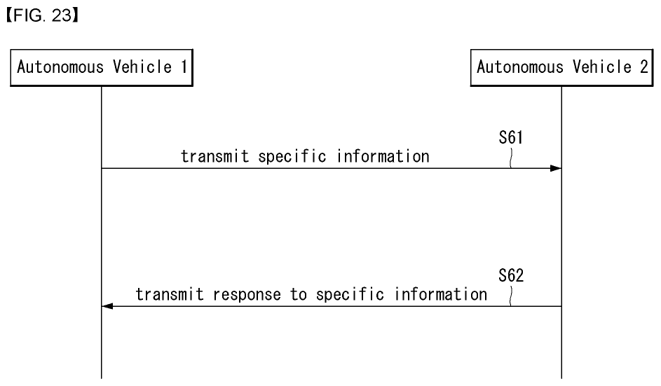

FIG. 23 illustrates an example of a basic vehicle-to-vehicle operation using 5G communication.

A first vehicle transmits specific information to a second vehicle at step S61.

The second vehicle transmits a response to the specific information to the first vehicle at step S61.

Here, the detailed description related to the transmission/reception of the specific information and the response to the specific information corresponds to the above-described operation of the V2X communication.

Meanwhile, the configuration of the vehicle-to-vehicle application operation may depend on whether the 5G network is directly (sidelink communication transmission mode 3) or indirectly (sidelink communication transmission mode 4) involved in the resource allocation of the specific information and the response to the specific information.

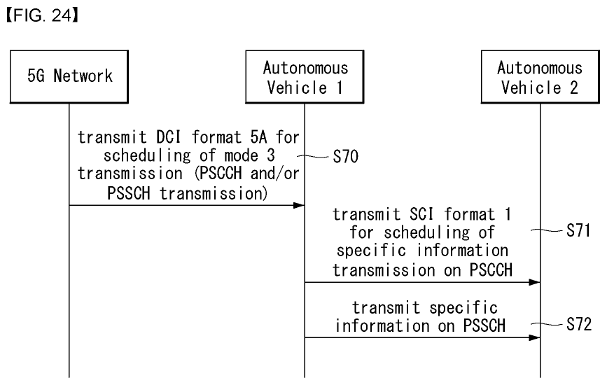

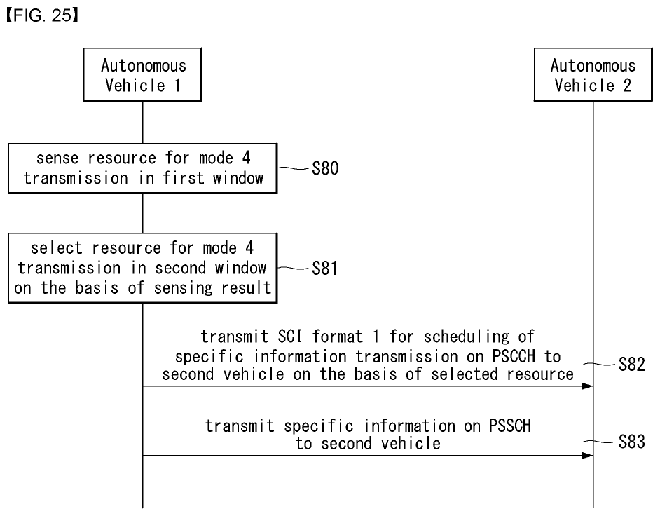

FIGS. 24 and 25 illustrate an example of a vehicle-to-vehicle application operation using 5G communication.

FIG. 24 illustrates an embodiment wherein the 5G network is directly involved in the resource allocation of the signal transmission/reception.

The 5G network may transmit a DCI format 5A to the first vehicle to schedule mode 3 transmission (transmission of PSCCH and/or PSSCH) at step S70.

Here, the PSCCH (physical sidelink control channel) is a 5G physical channel for scheduling the transmission of specific information, and the PSSCH (physical sidelink shared channel) is a 5G physical channel for transmitting the specific information.

The first vehicle transmits a SCI format 1 for scheduling the transmission of the specific information to the second vehicle on the PSCCH at step S71.

Furthermore, the first vehicle transmits the specific information to the second vehicle on the PSSCJ at step S72.

FIG. 25 illustrates an embodiment wherein the 5G network is indirectly involved in the resource allocation of the signal transmission/reception.

Referring to FIG. 25, the first vehicle senses a resource for mode 4 transmission on a first window at step S80.

Furthermore, the first vehicle selects the resource for the mode 4 transmission on a second window based on the sensed result at step S81.

Here, the first window means a sensing window, and the second window means a selection window.

The first vehicle transmits the SCI format 1 for scheduling the transmission of the specific information to the second vehicle on the PSCCH based on the selected resource at step S82.

Furthermore, the first vehicle transmits the specific information to the second vehicle on the PSSCH at step S83.

The above-described follow-mode control unit according to the embodiment of the present invention may be embodied as a computer readable code on a medium on which a program is recorded. The computer readable medium includes all kinds of recording devices in which data that can be read by the computer system is stored. Examples of the computer readable medium include Hard Disk Drives (HDD), Solid State Disks (SSD), Silicon Disk Drives (SDD), ROMs, RAM,s CD-ROMs, magnetic tapes, floppy disks, optical data storing devices and others. Furthermore, the computer readable medium may be embodied in the form of a carrier wave (e.g. transmission via the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Embodiment 1: An autonomous-driving control method includes setting a follow mode to follow a tracking vehicle; searching primary target vehicle candidates driving along the same driving path in a predetermined section, based on a V2X message received from surrounding vehicles; selecting a target vehicle to follow, among the primary target vehicle candidates; approaching a rear end of the selected target vehicle; and following the target vehicle while approaching the target vehicle.

Embodiment 2: In embodiment 1, the setting of the follow mode to follow the tracking vehicle may include determining a channel busy ratio; and setting a tracking mode, when the channel busy ratio is equal to or less than a preset threshold.

Embodiment 3: In embodiment 1, the searching of the primary target vehicle candidates may include searching a vehicle having the same running direction, which is predicted at the nearest intersection, based on driving history information and steering information of the V2X message.

Embodiment 4: In embodiment 1, the selecting of the target vehicle may include selecting, as the target vehicle, a vehicle having the largest vehicle body, among the primary target vehicle candidates.

Embodiment 5: In embodiment 1, the selecting of the target vehicle may include selecting, as the target vehicle, a vehicle whose driving speed is the highest, among the primary target vehicle candidates.

Embodiment 6: In embodiment 1, the selecting of the target vehicle may include selecting, as the target vehicle, a vehicle whose fuel efficiency is the highest, among the primary target vehicle candidates.

Embodiment 7: In embodiment 1, the selecting of the target vehicle may include calculating a first weight, based on a vehicle-body size of each of the primary target vehicle candidates; calculating a second weight, based on a driving speed of each of the primary target vehicle candidates; and selecting, as the target vehicle, a vehicle whose a sum of the first weight and the second weight is largest, among the primary target vehicle candidates.

Embodiment 8: In embodiment 1, at the approaching of the rear end of the target vehicle, a vehicle may approach an area where air resistance is reduced by the target vehicle.

Embodiment 9: In embodiment 1, the following of the target vehicle may further include determining whether the target vehicle deviates, based on the V2X message; and releasing the follow mode, when the target vehicle deviates from a host vehicle.

Embodiment 10: In embodiment 9, the determining whether the target vehicle deviates may include determining whether a situation in which a distance between the target vehicle and the host vehicle is increased by a traffic facility occurs.

Embodiment 11: In embodiment 9, the determining whether the target vehicle deviates may include determining whether a situation in which an expected driving path of the target vehicle is different from a driving path of the host vehicle occurs.

Embodiment 12: An autonomous-driving control apparatus may include an on board unit configured to receive a V2X message from surrounding vehicles; a follow-mode control unit configured to search primary target vehicle candidates driving along the same driving path in a predetermined section based on the V2X message, and to select a target vehicle to follow among the primary target vehicle candidates, in the case of setting a tracking mode; and an autonomous-driving control unit configured to control an actuating device to approach a rear end of the target vehicle and then follow the target vehicle, based on a determined result of the follow-mode control unit.

Embodiment 13: In embodiment 12, the follow-mode control unit may set the tracking mode, when a channel busy ratio is equal to or less than a preset threshold.

Embodiment 14: In embodiment 12, the follow-mode control unit may select, as the primary target vehicle candidates, a vehicle having the same running direction, which is predicted at the nearest intersection, based on driving history information and steering information of the V2X message.

Embodiment 15: In embodiment 12, the follow-mode control unit may select, as the target vehicle, a vehicle having the largest vehicle body, among the primary target vehicle candidates.

Embodiment 16: In embodiment 12, the follow-mode control unit may select, as the target vehicle, a vehicle whose driving speed is the highest, among the primary target vehicle candidates.

Embodiment 17: In embodiment 12, the follow-mode control unit may select, as the target vehicle, a vehicle whose fuel efficiency is the highest, among the primary target vehicle candidates.

Embodiment 18: In embodiment 12, the follow-mode control unit may calculate a first weight based on a vehicle-body size of each of the primary target vehicle candidates, calculate a second weight based on a driving speed of each of the primary target vehicle candidates, and select, as the target vehicle, a vehicle whose a sum of the first weight and the second weight is largest among the primary target vehicle candidates.

Embodiment 19: In embodiment 12, the autonomous-driving control unit may control the actuating device to approach an area where air resistance is reduced by the target vehicle.

Embodiment 20: In embodiment 12, the follow-mode control unit may determine whether the target vehicle deviates, based on the V2X message, and release the follow mode, when it is determined that the target vehicle deviates from a driving path.

Embodiment 21: In embodiment 20, the follow-mode control unit may determine that the target vehicle deviates, when a distance between the target vehicle and the host vehicle increases due to a traffic facility.

Embodiment 22: In embodiment 20, the follow-mode control unit may determine that the target vehicle deviates, when an expected driving path of the target vehicle is different from a driving path of the host vehicle.

Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. An autonomous-driving control method, comprising:
setting a follow mode to follow a tracking vehicle;
searching primary target vehicle candidates driving along the same driving path in a predetermined section, based on a V2X message received from surrounding vehicles;
selecting a target vehicle to follow, among the primary target vehicle candidates;
approaching a rear end of the selected target vehicle; and
following the target vehicle while approaching the target vehicle.

2. The autonomous-driving control method of claim 1, wherein the setting of the follow mode to follow the tracking vehicle comprises:
determining a channel busy ratio; and
setting a tracking mode, when the channel busy ratio is equal to or less than a preset threshold.

3. The autonomous-driving control method of claim 1, wherein the searching of the primary target vehicle candidates comprises:
searching a vehicle having the same running direction, which is predicted at the nearest intersection, based on driving history information and steering information of the V2X message.

4. The autonomous-driving control method of claim 1, wherein the selecting of the target vehicle comprises:
selecting, as the target vehicle, a vehicle having the largest vehicle body, among the primary target vehicle candidates.

5. The autonomous-driving control method of claim 1, wherein the selecting of the target vehicle comprises:
selecting, as the target vehicle, a vehicle whose driving speed is the highest, among the primary target vehicle candidates.

6. The autonomous-driving control method of claim 1, wherein the selecting of the target vehicle comprises:
selecting, as the target vehicle, a vehicle whose fuel efficiency is the highest, among the primary target vehicle candidates.

7. The autonomous-driving control method of claim 1, wherein the selecting of the target vehicle comprises:
calculating a first weight, based on a vehicle-body size of each of the primary target vehicle candidates;
calculating a second weight, based on a driving speed of each of the primary target vehicle candidates; and
selecting, as the target vehicle, a vehicle whose a sum of the first weight and the second weight is largest, among the primary target vehicle candidates.

8. The autonomous-driving control method of claim 1, wherein, at the approaching of the rear end of the target vehicle, a vehicle approaches an area where air resistance is reduced by the target vehicle.

9. The autonomous-driving control method of claim 1, wherein the following of the target vehicle further comprises:
determining whether the target vehicle deviates, based on the V2X message; and
releasing the follow mode, when the target vehicle deviates from a host vehicle.

10. The autonomous-driving control method of claim 9, wherein the determining whether the target vehicle deviates comprises:
determining whether a situation in which a distance between the target vehicle and the host vehicle is increased by a traffic facility occurs.

11. The autonomous-driving control method of claim 9, wherein the determining whether the target vehicle deviates comprises:
determining whether a situation in which an expected driving path of the target vehicle is different from a driving path of the host vehicle occurs.

12. The autonomous-driving control method of claim 1, further comprising:
transmitting a Sidelink Control Information (SCI) format 1 for scheduling transmission of driving history information and steering information of the surrounding vehicles to the following vehicle that sets the follow mode on a Physical Sidelink Control Channel (PSCCH); and
transmitting the driving history information and the steering information of the surrounding vehicles to the following vehicle on a Physical Sidelink Shared Channel (PSSCH).

13. The autonomous-driving control method of claim 12, wherein the transmission of the PSCCH and the PSSCH is based on a sidelink mode 4.

14. The autonomous-driving control method of claim 13, further comprising:
selecting a resource for the sidelink mode 4 transmission based on a first window and a second window.

15. An autonomous-driving control apparatus, comprising:
an on board module configured to receive a V2X message from surrounding vehicles;
a follow-mode controller configured to search primary target vehicle candidates driving along the same driving path in a predetermined section based on the V2X message, and to select a target vehicle to follow among the primary target vehicle candidates, in the case of setting a tracking mode; and
an autonomous-driving controller configured to control an actuating device to approach a rear end of the target vehicle and then follow the target vehicle, based on a determined result of the follow-mode control unit.

16. The autonomous-driving control apparatus of claim 15, wherein the follow-mode controller sets the tracking mode, when a channel busy ratio is equal to or less than a preset threshold.

17. The autonomous-driving control apparatus of claim 15, wherein the follow-mode controller selects, as the primary target vehicle candidates, a vehicle having the same running direction, which is predicted at the nearest intersection, based on driving history information and steering information of the V2X message.

18. The autonomous-driving control apparatus of claim 15, wherein the follow-mode controller selects, as the target vehicle, a vehicle having the largest vehicle body, among the primary target vehicle candidates.

19. The autonomous-driving control apparatus of claim 15, wherein the follow-mode controller selects, as the target vehicle, a vehicle whose driving speed is the highest, among the primary target vehicle candidates.

20. The autonomous-driving control apparatus of claim 15, wherein the follow-mode controller selects, as the target vehicle, a vehicle whose fuel efficiency is the highest, among the primary target vehicle candidates.

21. The autonomous-driving control apparatus of claim 15, wherein the follow-mode controller calculates a first weight based on a vehicle-body size of each of the primary target vehicle candidates, calculates a second weight based on a driving speed of each of the primary target vehicle candidates, and selects, as the target vehicle, a vehicle whose a sum of the first weight and the second weight is largest among the primary target vehicle candidates.

22. The autonomous-driving control apparatus of claim 15, wherein the autonomous-driving controller controls the actuating device to approach an area where air resistance is reduced by the target vehicle.

23. The autonomous-driving control apparatus of claim 15, wherein the follow-mode controller determines whether the target vehicle deviates, based on the V2X message, and releases the follow mode, when it is determined that the target vehicle deviates from a driving path.

24. The autonomous-driving control apparatus of claim 15, wherein the follow-mode controller determines that the target vehicle deviates, when a distance to the target vehicle is equal to or more than a preset critical distance due to a traffic facility.
